(19) United States
(12) Patent Application Publication
(10) Pub. No.: US 2024/0253779 A1
(43) Pub. Date: Aug. 1, 2024

(54) CONNECTOR ON AIRCRAFT SENSOR

(71) Applicant: Supernal, LLC, Washington, DC (US)

(72) Inventors: Vahid NAVIDI, Peoria, AZ (US); Schirley CZERNICHOVSKI, Irvine, CA (US)

(73) Assignee: Supernal, LLC, Washington, DC (US)

(21) Appl. No.: 18/423,747

(22) Filed: Jan. 26, 2024

Related U.S. Application Data
(60) Provisional application No. 63/481,817, filed on Jan. 27, 2023.

(51) Int. Cl. B64C 29/00; G01P 13/02

(52) U.S. Cl. CPC B64C 29/0091; G01P 13/025

(57) ABSTRACT

A sensor configured for use with a vertical takeoff and landing capable aircraft (VTOL aircraft) includes a probe portion configured to extend outward of an outer surface of the VTOL aircraft. The probe portion includes a distal end formed by a probe on a first side of the sensor. The sensor has an interior portion configured to extend within the outer surface of the VTOL aircraft, the interior portion including a proximal end having an electrical connector on a second side of the sensor, the second side being opposite the first side.

### CROSS REFERENCE TO RELATED APPLICATION

This application claims priority to U.S. Provisional Application No. 63/481,817 filed Jan. 27, 2023, which is incorporated by reference herein in its entirety.

### TECHNICAL FIELD

The present disclosure relates to systems, devices, and methods for aircraft sensors and aircraft sensor systems. More particularly, the present disclosure relates to systems, devices, and methods for an aircraft sensor suitable for use with vehicles capable of vertical takeoff and landing, and in particular, an aircraft sensor suitable for electrically-powered vehicles capable of vertical takeoff and landing.

### BACKGROUND OF THE INVENTION

Modern aircraft are complex, sophisticated vehicles that use computing systems to assist pilots and automate various functions of the aircraft during flight. Whether the aircraft is under manual operation, semi-autonomous operation, or fully-autonomous operation, flight information is necessary for understanding the state of the aircraft and current conditions outside the aircraft. This flight information is collected by various sensors, including sensors extending outside of the aircraft, and digitized for use by aircraft computing systems.

One exemplary type of aircraft sensor is a Pitot probe, which functions as a speedometer, measuring air speed based on airflow across the sensor. Other sensors measure altitude (e.g., via static pressure), temperature outside of the aircraft, angle of attack, and other conditions. These sensors protrude outside of the outer skin of the aircraft to operate and also include structures installed within the aircraft, such as pneumatic hoses, circuitry, electrical connections, and others.

In larger aircraft (e.g., aircraft capable of transporting dozens or hundreds of passengers, large amounts of cargo, etc.), there is ample space inside the skin of the aircraft to accommodate the internal structures of these sensors, including electrical connections and wiring. However, smaller aircraft, which include at least some vertical takeoff and landing vehicles, have significantly less space available. For example, sensors that require depths of 7.0 inches or more inside the aircraft skin are inappropriate for use in some smaller aircraft and/or in some vertical takeoff and landing capable aircraft. Additionally, existing sensors are difficult to place in the limited number of suitable surfaces on these aircraft, and introduce challenges due to the need to route pneumatic hoses to the sensors. Some existing sensors also have size, weight, and power characteristics that are not suited for a vertical takeoff and landing aircraft, and in particular, an electrically-powered vertical takeoff and landing aircraft.

The present disclosure is directed to addressing one or more of these above-described challenges. However, the scope of the present disclosure is not limited by the ability to address a particular challenge or solve a particular problem.

### SUMMARY OF THE DISCLOSURE

In one aspect, a sensor configured for use with a vertical takeoff and landing capable aircraft (VTOL aircraft) may include a probe portion configured to extend outward of an outer surface of the VTOL aircraft. The probe portion may include a distal end formed by a probe on a first side of the sensor. The sensor may have an interior portion configured to extend within the outer surface of the VTOL aircraft, the interior portion including a proximal end having an electrical connector on a second side of the sensor, the second side being opposite the first side.

In another aspect, a sensor may include a probe portion configured to protrude outside of an aircraft, a housing configured to extend within a housing of the aircraft, and a flange connecting the probe portion to the housing. The sensor may also include a distal end formed by the probe portion, an airdata computer contained within the housing, the housing having a proximal side and a distal side, and an electrical connector at the proximal side or the distal side of the housing.

In yet another aspect, an aircraft may include an outer surface and a sensor, the sensor including a probe portion that extends outward of the outer surface of the aircraft. The probe portion may include a distal end formed by a probe. The sensor The sensor may include an interior portion extending inside the outer surface of the aircraft, the interior portion including a housing and an electrical connector on a proximal side or a distal side of the housing. The aircraft may further include wiring extending from the electrical connector at the proximal end of the sensor.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective view of an exemplary electric vehicle with vertical takeoff and landing capabilities with one or more sensors, according to one or more embodiments.

FIG. 2 is a side view of the exemplary vehicle of FIG. 1 showing a plurality of sensors, according to one or more embodiments.

FIG. 3 is a partially-schematic side view of an exemplary sensor, according to one or more embodiments.

FIG. 4 is a partially-schematic side view of the sensor installed in an aircraft, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

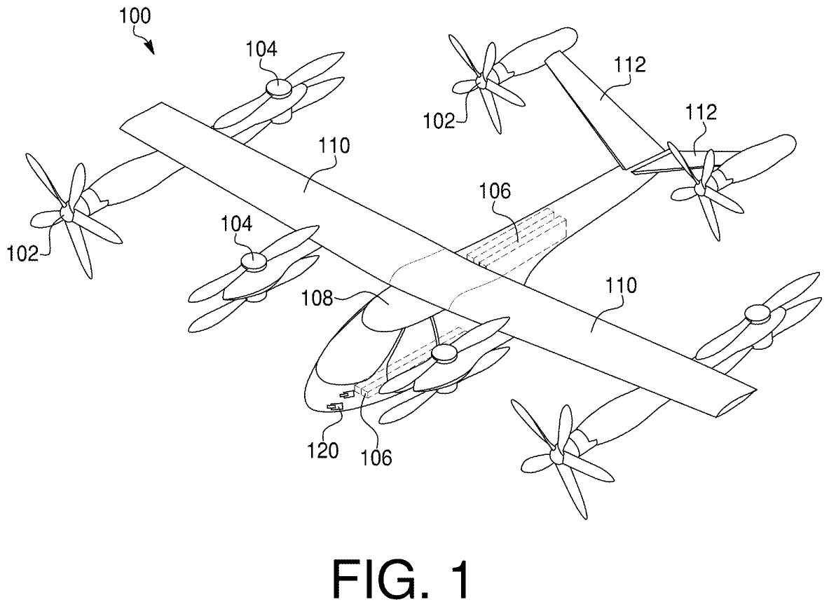

FIG. 1 is a perspective view of an exemplary vehicle with vertical takeoff and landing capabilities, referred to herein as a “VTOL”, according to one or more embodiments. The exemplary vehicle may be an electric (e.g., battery-powered) vehicle capable of vertical takeoff and landing, also referred to herein as an “eVTOL”.

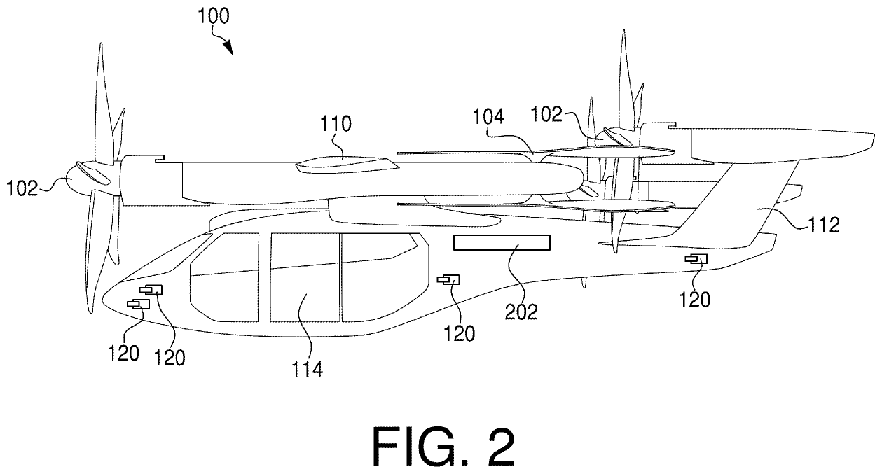

An exemplary eVTOL or VTOL 100 according to the present disclosure may include a fuselage 108 and two or more wings extending from fuselage 108, with two front wings 110 and two rear wings 112 being shown in FIG. 1. Fuselage 108 may define an outermost exterior surface of VTOL 100, which can also be referred to as a “skin” of VTOL 100. A plurality of propulsion-generating assemblies may be connected to wings 110 connected to fuselage 108. The propulsion-generating assemblies may each include rotor assemblies having one or more propellers. The configuration of VTOL 100 in the Figures includes a plurality of tilt-capable rotors 102 (two labelled in FIG. 1) that are each movable between a horizontal configuration (FIG. 1) for wing-borne flight and a vertical configuration (FIG. 2) for rotor-borne flight. This configuration also includes lift rotors 104 (two being labelled in FIG. 1) that may have a fixed orientation (i.e., rotors that are not tiltable).

Energy storage devices 106 (e.g., batteries) may be configured to store and supply electric energy to electric motors that drive rotors 102 and 104 to enable flight. The locations of energy storage devices 106 shown in FIG. 1 are exemplary, energy storage devices 106 may be located within or attached to front wings 110 or rear wings 112, or within booms attached to front wings 110 or rear wings 112.

One or more sensors 120 may be secured to the outermost surface or “skin” of VTOL 100. Sensors 120 may each be configured to provide information to the electronic control system, including Pitot pressure, static pressure, angle of attack (“AOA”), angle of sideslip (“AOS”), and environmental temperature. In at least some embodiments, sensors 120 are secured in a manner that allows each sensor 120 to extend through the skin of VTOL 100. Each sensor 120 may form a sensor assembly including one or more of: a Pitot sensor element, static pressure element, AOA element, AOS element, or temperature element. However, in at least some embodiments, sensor 120 may be only a pressure sensor (e.g., only a Pitot sensor, only a static pressure sensor, or a combination of only a Pitot sensor and static pressure sensor). Sensor 120 may be free of a heater, may include a reduced-power heater (e.g., a heater suitable for use at altitudes of 5,000 feet or less), or may include a high-power heater (e.g., a heater suitable for use at altitudes of 5,000 feet or more).

Sensor 120 may be located near a nose of VTOL 100 (e.g., in front of a passenger cabin 114, shown in FIG. 2), as shown in FIG. 1. However, additional or alternate locations may be used. For example, FIG. 2 illustrates exemplary locations of sensors 120. VTOL 100 may include any number of sensors 120, such as one sensor 120, two sensors 120, three sensors 120, four sensors 120, or more, at any combination of the locations described herein, or at other locations. Sensor 120 may be located at or near a rear of VTOL 100 (e.g., overlapping rear wing(s) 112 and behind passenger cabin 114 and rotors 102), at a central portion of VTOL 100 (e.g., overlapping front wings 110 and/or between rear wings 112 and passenger cabin 114), and/or near the nose (e.g., in front of passenger cabin 114), as indicated above. Sensors 120 may be placed at locations where air flow generated from rotors 102 and 104 does not interfere with measurements taken with, for example, Pitot tube elements of the sensor, for at least some stages or types of flight.

Sensors 120 may be secured at multiple locations along VTOL 100 to facilitate the detection of different flight characteristics, or the detection of a particular characteristic by different sensors. For example, different sensors 120 may detect the same characteristic at the same time for redundancy, or may detect the same characteristic at different times (e.g., with different sensors 120 being used for different stages of flight). For example, multiple sensors may each measure Pitot pressure, static pressure, angle of attack (“AOA”), angle of sideslip (“AOS”), and environmental temperature, or the same combination of these characteristics, to provide redundancy and assist in identifying unreliable measurements. In at least some configurations, one or more first sensors 120 may detect Pitot pressure and static pressure, while one or more second sensors 120 detect angle of attack, angle of sideslip, and/or environmental temperature.

FIG. 2 also shows an aircraft controller 202. Controller 202 may be in communication with sensors 120, either directly or indirectly (e.g., via electrical communication with an airdata computer incorporated in each sensor 120, as described below). Controller 202 may be a flight control computer or other supervisory system that manages one or more aspects of VTOL 100 during flight.

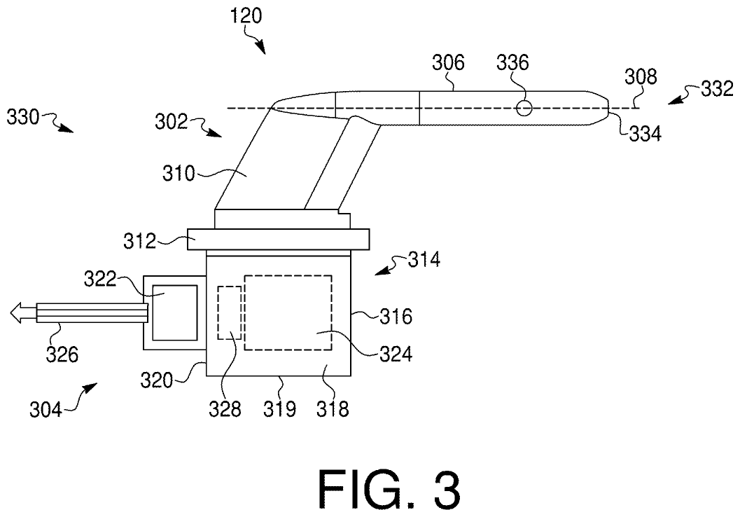

Controller 202 may be configured to receive data from one or more sensors 120 (e.g., via respective airdata computers 324, shown in FIG. 3 and described below, of each sensor). Controller 202 may be configured to generate outputs for VTOL 100 based on the signals from sensors 120. For example, controller 202 may be configured to generate a display that indicates airspeed, altitude, angle of attack, angle of sideslip, temperature, and other items of information, based on signals from sensors 120. Additionally or alternatively, controller 202 may be configured to control operation of VTOL 100 (e.g., generating signals to change position of one or more control surfaces via pilot assistance functions, autopilot functions, etc.), based on signals from sensors 120.

FIG. 3 shows a side view of sensor 120. As shown in FIG. 3, sensor 120 may be formed with two sections or portions, including a probe portion 302 that extends outside of an outer skin of VTOL 100 when sensor 120 is installed, and an interior portion 304 that extends, in some cases entirely, underneath the skin of VTOL 100 and within the fuselage of VTOL 100 when sensor 120 is installed. Portions 302 and 304 may form a single integrated sensor unit that includes both a probe assembly (e.g., probe portion 302) and an airdata computer 324.

Probe portion 302 of sensor 120 may include a probe body 306 that forms a distal end of sensor 120 on a distal side 332 of sensor 120. An electrical connector or electrical interface 322 may be formed at an opposite proximal end on a proximal side 330 of sensor 120. Sensor 120 may include a bridge 310 connecting a flange 312 to probe body 306. Interior portion 304 may include an in-aircraft housing 314 that contains airdata computer 324. Electrical interface 322 may connect to a printed wiring board and/or printed circuit board 328 of airdata computer 324.

Probe body 306 may include Pitot measurement elements (i.e., a Pitot tube), as shown in FIG. 3. Probe body 306 may define a longitudinal axis 308 that extends in a proximal-to-distal direction, or may extend in a different direction (e.g., oblique to a horizontal direction that extends from the nose of VTOL 100). If desired, probe body 306 or other structures of probe portion 302 may include elements (e.g., static pressure ports, a pressure sensor, a thermistor, etc.) for making one or more of the above-described types of measurements. In the illustrated example, probe body 306 includes a pitot port 334 at the distal end of probe body 306 and a static pressure sensing port 336.

Bridge 310 may extend at an angle to connect probe body 306 to flange 312. Flange 312 may include structures (e.g., bolts or other fasteners) that enable sensor 120 to be secured to VTOL 100. Flange 312 may include an outward-facing surface and an opposite inward-facing surface. The inward-facing surface may be secured to in-aircraft housing 314.

Housing 314 may have the general shape of a rectangular prism. Housing 314 may include a distal-facing side 316, a proximal-facing side 320, an outward side (not labelled) formed at the interface of housing 314 and flange 312 at the top of housing 314, a bottom side 319, and two lateral sides 318 (one visible in FIG. 3) extending between distal-facing side 316 and proximal-facing side 320. Bottom side 319 may face in a direction opposite of bridge 310 (downward in FIG. 3), while lateral sides 318 extend from flange 312 to the side opposite of bridge 310.

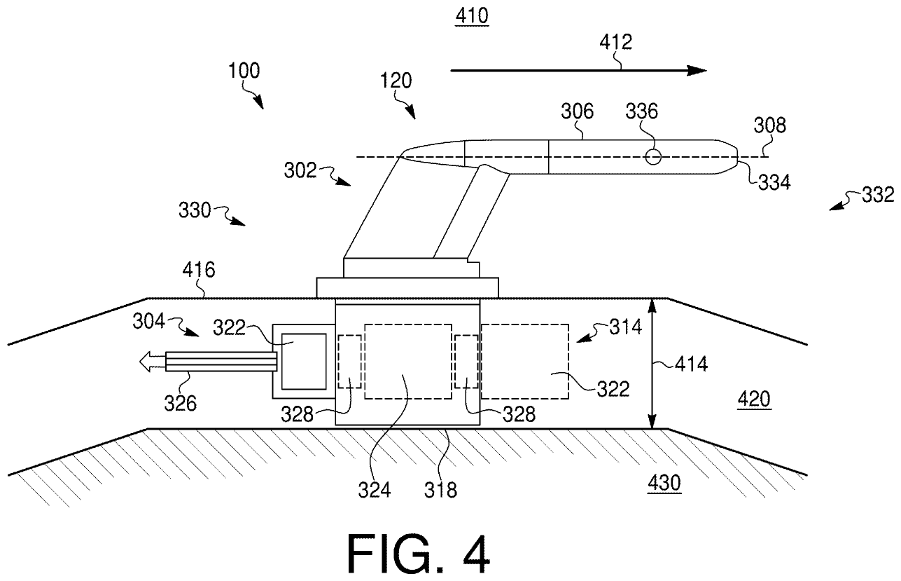

In the embodiment shown in FIG. 3, proximal-facing side 320 includes electrical connector 322. However, if desired, distal-facing side 316 may include electrical interface 322 (not shown in FIG. 3; represented by dashed lines in FIG. 4). In some configurations, both proximal-facing and distal-facing sides 320 and 316 may include an electrical interface 322. Bottom side 319 may be free of an electrical interface, facilitating space reduction when sensor 120 is installed in VTOL 100. If desired, lateral sides 318 may also be free of an electrical interface, allowing for space reduction in a lateral direction. As shown in FIG. 3, electrical interface 322 may protrude outward from housing 314. However, electrical interface 322 does not increase a footprint of sensor 120 in a thickness direction that extends from bridge 310 to housing 314 (a direction extending through bottom side 319 and flange 312 in a direction perpendicular to a proximal-distal direction extending from proximal side 330 toward distal side 332).

Electrical connector 322 may be permanently or removably connected to wiring 326. Wiring 326 may enable communication between airdata computer 324 and aircraft controller 202 (FIG. 2), for example. Wiring 326 may extend in a generally proximal direction (as shown in FIG. 3) or in a generally distal direction. Wiring 326 may be free of sharp bending at locations immediately adjacent to electrical interface 322, to ensure safety and reliability. For example, wiring 326 may be free of turns in excess of about 45 degrees, in excess of about 60 degrees, or in excess of about 85 degrees, within the vicinity (e.g., within 1.0 inch) of electrical interface 322. Thus, wiring 326 may extend in a proximal direction away from electrical interface 322 (or alternatively, in a distal direction away from electrical interface 322 when interface 322 is located on distal-facing side 316 of housing 314) and be free of turns for a distance of at least about 1.0 inch, at least about 2.0 inches, at least about 3.0 inches, at least about 5.0 inches, or longer distances.

While wiring 326 is shown connected to an exterior of electrical interface 322 and interface 322 is shown protruding from proximal-facing side 320, as understood, wiring 326 may extend to an interior of electrical interface 322. Additionally, electrical interface 322 may be formed as openings or recesses in proximal-facing side 320 of housing 314, such that electrical interface 322 is located within housing 314.

FIG. 4 shows a side view with sensor 120 installed in VTOL 100. As shown in FIG. 4, when sensor 120 is installed, that probe portion 302 extends outside of a skin 416 of VTOL 100, while interior portion 304 is located within an open space 420 of an interior of VTOL 100.

As indicated above, while electrical interface 322 is shown on the distal side of housing 314, electrical interface 322 may be provided at the proximal side of housing 314, as represented by the dashed-line box on the proximal side of housing 314 in FIG. 4. Electrical interface 322 may be recessed within this side of housing 314 or may protrude in a proximal direction from housing 314. Similarly, printed circuit board 328 may be positioned on the proximal side of housing 314. A proximally-extending electrical interface 322, when present, may be provided instead of the distally-extending electrical interface 322 or in addition to the distally-extending electrical interface 322.

In some aspects, space 420 may have a width 414 defined at the location where sensor 120 is installed. Width 414 may define a gap between skin 416 and material 430. Material 430 may include an interior wall, insulation material, or other structures separating an interior (e.g., cabin) of VTOL 100 from skin 416. Width 414 may be less than about 7.0 inches, less than about 6.0 inches, or less than about 5.0 inches. In some aspects, width 414 may be equal to or less than about 4.0 inches, equal to or less than about 3.0 inches, or equal to or less than about 3.0 inches.

Width 414 may be approximately equal to the width of housing 314 (e.g., within about 0.25 inch of the width of housing 314, or within about 0.50 inch of the width of housing 314, as measured in the same direction as width 414 when sensor 120 is installed). For example, a width of housing 314, as measured from side 318 facing material 430) to flange 312, may be about 4.0 inches, and width 414 may be slightly larger than about 4.0 inches. In other examples, width 414 may be greater than the width of housing 314 by a larger amount. Even in configurations where width 414 is significantly larger than the width of housing 314, placing electrical interface 322 on a proximal side 330 of sensor 120 may avoid the need to provide a sharp turn (e.g., a 90 degree turn) in wiring 326, as described above.

Skin 416 may form a generally curved surface (represented by a series of angled lines in FIG. 4). This curved surface may extend generally parallel to longitudinal axis 308. Further, when VTOL 100 travels forward (e.g., during cruising) along a direction of travel 412, this direction of travel 412 may be generally parallel to longitudinal axis 308, with axis 308 extending in a proximal-to-distal direction, as indicated above. Thus, a distal end formed by a tip of probe body 306 may oppose a proximal end formed by electrical interface 322, in a direction parallel to direction of travel 412 and parallel to skin 416, ignoring the curvature of skin 416. This may facilitate insertion of sensor 120 in a relatively small vehicle, such as VTOL 100.

While sensor 120 has been described in combination with a particular type of electric vehicle, sensor 120 may be used in other types of aircraft and/or other types of vehicles. As one example, sensor 120 may be used in other types (e.g., non-electrically powered) VTOLs, or other types of commercial or recreational aircraft or vehicles. Sensor 120 may be useful in any vehicle in which one or more sensors are secured within a limited space and in which it is desirable to provide an electrical connection within this space.

It should be appreciated that in the above description of exemplary embodiments, various features are sometimes grouped together in a single embodiment, figure, or description thereof for the purpose of streamlining the disclosure and aiding in the understanding of one or more of the various aspects of present disclosure. This method of disclosure, however, is not to be interpreted as reflecting an intention that claimed subject matter requires more features than are expressly recited in each claim. Rather, as the following claims reflect, various aspects of the disclosure lie in less than all features of a single foregoing disclosed embodiment. Thus, the claims following the Detailed Description are hereby expressly incorporated into this Detailed Description, with each claim standing on its own as a separate embodiment of the present disclosure.

Furthermore, while some embodiments described herein include some but not other features included in other embodiments, combinations of features of different embodiments are meant to be within the scope of this disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the present disclosure. For example, functionality may be added or deleted from the block diagrams and operations may be interchanged among functional blocks. Steps may be added or deleted to methods described within the scope of the present disclosure.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A sensor configured for use with a vertical takeoff and landing capable aircraft (VTOL aircraft), the sensor comprising:
a probe portion configured to extend outward of an outer surface of the VTOL aircraft, the probe portion including:
a distal end formed by a probe on a first side of the sensor; and
an interior portion configured to extend within the outer surface of the VTOL aircraft, the interior portion including:
a proximal end having an electrical connector on a second side of the sensor, the second side being opposite the first side.

2. The sensor of claim 1, further including:
a housing between the electrical connector and a flange of the probe portion; and
an airdata computer within the housing.

3. The sensor of claim 1, wherein the probe portion includes a Pitot port.

4. The sensor of claim 1, wherein the probe portion includes a static pressure port.

5. The sensor of claim 1, further including a housing that contains an airdata computer, the housing having a proximal side, a lateral side, and a distal side, the electrical connector formed on proximal side.

6. The sensor of claim 5, wherein the housing is configured to extend within an interior space of the VTOL aircraft when the sensor is installed with the probe portion outside of the VTOL aircraft, such that the lateral side faces insulation or an interior wall of the VTOL aircraft.

7. The sensor of claim 6, further including a flange that bridges the probe portion and the interior portion, wherein a width of the housing, as measured from the lateral side to the flange, is less than about 4.0 inches.

8. A sensor, comprising:
a probe portion configured to protrude outside of an aircraft;
a housing configured to extend within a housing of the aircraft;
a flange connecting the probe portion to the housing;
a distal end formed by the probe portion;
an airdata computer contained within the housing, the housing having a proximal side and a distal side; and
an electrical connector at the proximal side or the distal side of the housing.

9. The sensor of claim 8, further including a computer within the housing, the electrical connector configured to connect wiring such that the wiring is in electrical communication with the computer.

10. The sensor of claim 9, further including a circuit board within the housing and connected between wiring and the computer.

11. An aircraft, comprising:
an outer surface;
a sensor including:
a probe portion that extends outward of the outer surface of the aircraft, the probe portion including:
a distal end formed by a probe; and
an interior portion extending inside the outer surface of the aircraft, the interior portion including:
a housing; and
an electrical connector on a proximal side or a distal side of the housing; and
wiring extending from the electrical connector.

12. The aircraft of claim 11, wherein the probe portion defines a longitudinal axis that extends substantially parallel to the outer surface of the aircraft and the electrical connector opens in a direction that is substantially parallel to the outer surface of the aircraft.

13. The aircraft of claim 11, further including a gap formed between the outer surface and material within the aircraft, the interior portion of the sensor being secured within the gap.

14. The aircraft of claim 13, wherein the gap is about 4.0 inches or less.

15. The aircraft of claim 13, wherein the material includes an interior wall or insulation.

16. The aircraft of claim 11, wherein the electrical connector is formed on the proximal side of the housing and the wiring extends approximately parallel to a longitudinal axis defined by the probe from a point at which the wiring connects to the proximal side of the sensor.

17. The aircraft of claim 11, further including a computer connected to the wiring and provided within the housing.

18. The aircraft of claim 17, wherein a bottom side of the housing faces an interior wall or insulation of the aircraft.

19. The aircraft of claim 18, wherein the bottom side is free of an electrical connector.

20. The aircraft of claim 18, further including a flange that bridges the probe portion and the interior portion, wherein a width of the housing, as measured from the bottom side to the flange, is less than about 4.0 inches.
